(19) United States
(12) Patent Application Publication
(10) Pub. No.: US 2014/0189804 A1
(43) Pub. Date: Jul. 3, 2014

(54) LOCATION-BASED APPLICATION SECURITY MECHANISM

(71) Applicants: Doron Lehmann, Kfar Vradim (IL); Eyal Nathan, Tel Aviv (IL); Nimrod Barak, Tel Aviv (IL)

(72) Inventors: Doron Lehmann, Kfar Vradim (IL); Eyal Nathan, Tel Aviv (IL); Nimrod Barak, Tel Aviv (IL)

(73) Assignee: SAP AG, Walldorf (DE)

(21) Appl. No.: 13/732,792

(22) Filed: Jan. 2, 2013

(51) Int. Cl. H04W 12/08

(52) U.S. Cl. CPC H04W 12/08
USPC 726/4

(57) ABSTRACT

The present disclosure describes methods, systems, and computer program products for providing a location-based application content security mechanism to a web portal. One computer-implemented method includes receiving a request for portal content from a client device, determining that the requested portal content has an established geo-location permission, requesting a client geo-location from the requesting client device, receiving the client geo-location from the requesting client device, determining, by operation of a computer, that the received client geo-location is within a required geo-location threshold associated with at least one geo-location data point associated with the established geo-location permission, and serving the portal content to the requesting client device.

### BACKGROUND

A web portal application may use various authentication methods to restrict user access to content. For example, authentication methods often used include HTTP access authentication requiring a user name and password, cookies, sessions, and/or various codes, protocols, or encryption methods. Web portals, however, do not have an ability to restrict user access to portal content based on the geographic location of the user. As a result, improper use of a user name and password, codes, and the like can allow undesired access to portal content and breaches in web portal security.

### SUMMARY

The present disclosure relates to computer-implemented methods, computer-readable media, and computer systems for providing a location-based application content security mechanism to a web portal. One computer-implemented method includes receiving a request for portal content from a client device, determining that the requested portal content has an established geo-location permission, requesting a client geo-location from the requesting client device, receiving the client geo-location from the requesting client device, determining, by operation of a computer, that the received client geo-location is within a required geo-location threshold associated with at least one geo-location data point associated with the established geo-location permission, and serving the portal content to the requesting client device.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the at least one geo-location data point is established by at least one of a map coordinate, a global positioning system (GPS) coordinate, an address, or a location.

A second aspect, combinable with any of the previous aspects, wherein the client geo-location is determined by at least one of a global positioning system (GPS) receiver in the client device, a triangulation-based method using cellular signals, a triangulation-based method using wireless Internet signals, or an Internet protocol (IP) address.

A third aspect, combinable with any of the previous aspects, wherein the geo-location threshold can vary based upon threshold parameters.

A fourth aspect, combinable with any of the previous aspects, wherein the threshold parameters include at least one of a time, a date, a result of a dynamic calculation, or an external event.

A fifth aspect, combinable with any of the previous aspects, further comprising checking a plurality of authorization criteria associated with the request for portal content.

A sixth aspect, combinable with any of the previous aspects, wherein the plurality of authorization criteria comprises at least one of a user name, a user role, or a user group.

A seventh aspect, combinable with any of the previous aspects, further comprising, in response to determining that the received specific geo-location is outside the required geo-location threshold, sending a notification indicating a denial of access to the requested portal content based upon the client geo-location.

The subject matter described in this specification can be implemented in particular implementations so as to realize one or more of the following advantages. The location-based application security mechanism can allow sensitive portal content to be shielded from unintended or unauthorized access from non-permitted locations. For example, certain sensitive portal content may be defined to be restricted from viewing or published from predetermined geographical locations. The sensitive portal content can be provided to client requests only when the client is located in a permitted-access region or threshold around a defined geographical location. If attempts to access the sensitive portal content originate from outside the geographical location threshold, the access operation can be denied, guaranteeing the safety of the sensitive portal content. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system for providing a location-based application security mechanism to a web portal.

FIG. 2 is a flow chart illustrating a method for providing a location-based application security mechanism to a web portal.

FIG. 3 is a flow chart illustrating a method for a web portal administrator to set up a location-based application security mechanism.

FIGS. 4A and 4B are example graphical user interfaces providing functionality to establish a location-based application security mechanism.

FIG. 5 is a block diagram of an example map interface for setting a geo-location geo-permission threshold.

Like reference numbers and designations in the various drawings indicate like elements.

### DETAILED DESCRIPTION

This disclosure generally describes computer-implemented methods, computer-program products, and systems for providing a location-based application content security mechanism to a web portal.

For the purposes of this disclosure, a web-based enterprise portal (EP) is a framework for integrating information, people, and processes across organizational boundaries. An EP provides a secure unified access point, often in the form of a web-based user interface, and is designed to aggregate and personalize information through application-specific portals. The EP is a de-centralized content contribution and content management system, which keeps the information always updated. With a web browser, enterprise portal users can begin work once they have been authenticated in the EP which offers a single point of access to information, enterprise applications, and services both inside and outside an organization. EPs may present information from diverse sources on mobile or other devices in a unified and structured way, for example using HTML container documents, and provide additional services, such as dashboards, an internal search engine, e-mail, news, navigation tools, and various other features. EPs are often used by enterprises for providing their employees, customers, and possibly additional users with a consistent look and feel, and access control and procedures for multiple applications, which otherwise would have been separate entities altogether.

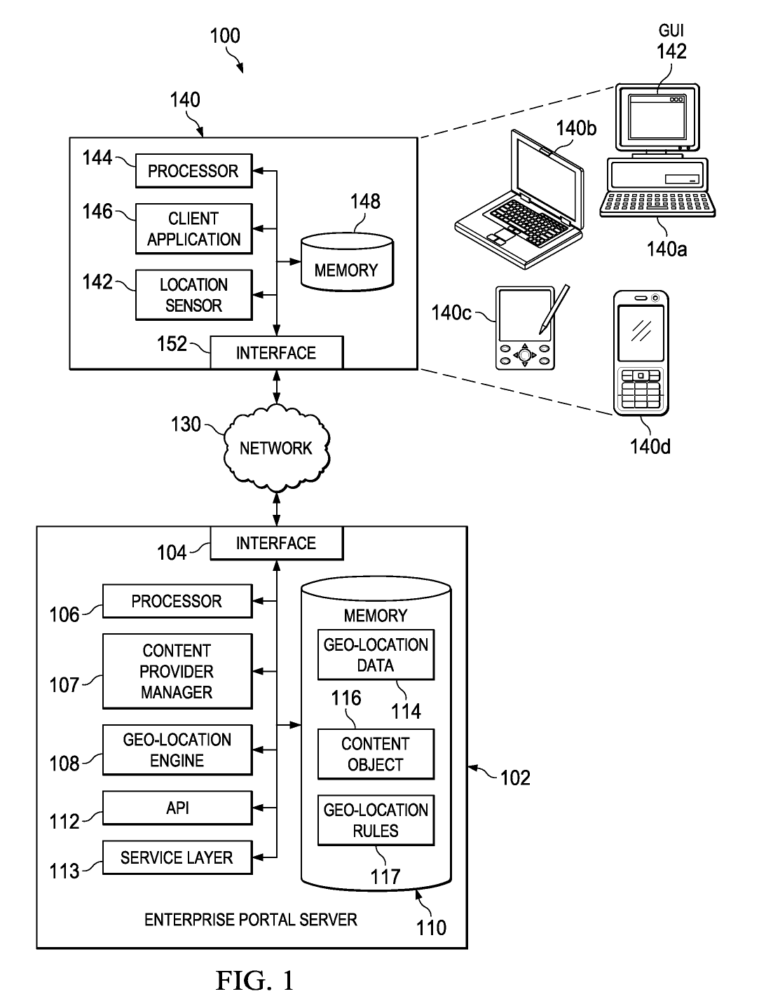

FIG. 1 is a block diagram illustrating an example distributed computing system for providing a location-based application content security mechanism to a web portal. The illustrated example distributed computing system 100 includes or is communicably coupled with an enterprise portal server (EPS) 102 and a client 140 (described below) that communicate across a network 130 (described below).

At a high level, the EPS server 102 is an electronic computing device operable to receive, transmit, process, store, or manage data and information associated with the example distributed computing system 100. Generally, the EPS server 102 allows users to navigate to, view, compose, modify, delete, and deploy enterprise portal container documents. Specifically, the described computer-implemented methods, software, and systems provide functionality for providing a location-based application content security mechanism to a web portal through one or more graphical user interfaces (GUIs) providing a user with an efficient and user-friendly presentation of data provided by or communicated within the example distributed computing system 100.

The EPS 102 is responsible for receiving application requests, such as requests for specified portal content from one or more client applications 146 (described below) associated with the client 140 of the example distributed computing system 100 and responding to the received requests by processing said requests in a content provider manager 107 (described below), and sending the appropriate response/content from the content provider manager 107 back to the requesting client application 146. In addition to requests from the client 140, requests associated with the content provider manager 107 may also be sent from internal users, external or third-party customers, other automated applications, as well as any other appropriate entities, individuals, systems, or computers. According to one implementation, EPS 102 may also include or be communicably coupled with an e-mail server, a web server, a caching server, a streaming data server, and/or other suitable server. In some implementations, the requests for specified portal content can include confidential, privileged, or classified material that will be sent from the content provider manager 107 only when certain authentication criteria, for example geographic location (i.e., geo-location)-based criteria, are met. The present disclosure includes a location-based application content security mechanism that can enable certain confidential, privileged, or classified material to be accessed from the client 140 within predefined geo-location thresholds.

The EPS 102 includes at least a content provider manager 107 and a geo-location engine 108 where at least a portion of the content provider manager 107 and/or the geo-location engine 108 is operated using requests/responses sent from/to a client 140 within and communicably coupled to the illustrated example distributed computing system 100 using the network 130. In some implementations, requests/responses can be sent directly to EPS 102 from a user accessing EPS 102 directly. In some implementations, the EPS 102 may store a plurality of content provider managers 107 and/or geo-location engines 108. In some implementations, the EPS 102 may include a web server, where one or more of the components of EPS 102 represent web-based applications accessed and executed by the client 140 using the network 130 or directly at the EPS 102 to perform the programmed tasks or operations of the various components of EPS 102.

In some implementations, any and/or all of components of the EPS 102, both hardware and/or software, may interface with each other and/or the interface using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the example distributed computing system 100. The functionality of the EPS 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the EPS 102 in the example distributed computing system 100, alternative implementations may illustrate the API 112 and/or the service layer 113 as stand-alone components in relation to other components of the example distributed computing system 100. Moreover, any or all parts of the API 112 and/or the service layer 113 may be implemented as child or sub-modules of another software module, enterprise application, or hardware module without departing from the scope of this disclosure.

The EPS 102 includes an interface 104. Although illustrated as a single interface 104 in FIG. 1, two or more interfaces 104 may be used according to particular needs, desires, or particular implementations of the example distributed computing system 100. The interface 104 is used by the EPS 102 for communicating with other systems in a distributed environment—including within the example distributed computing system 100—connected to the network 130; for example, the client 140 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

The EPS 102 includes a processor 106. Although illustrated as a single processor 106 in FIG. 1, two or more processors may be used according to particular needs, desires, or particular implementations of the example distributed computing system 100. Generally, the processor 106 executes instructions and manipulates data to perform the operations of the EPS 102. Specifically, the processor 106 executes the functionality required to provide a location-based application content security mechanism to a web portal.

The EPS 102 also includes a memory 110 that holds data for the EPS 102. Although illustrated as a single memory 110 in FIG. 1, two or more memories may be used according to particular needs, desires, or particular implementations of the example distributed computing system 100. While memory 110 is illustrated as an integral component of the EPS 102, in alternative implementations, memory 110 can be external to the EPS 102 and/or the example distributed computing system 100. In some implementations, the memory 110, i.e., the content repository that holds the description and/or data for all objects in the ERP 102, includes one or more instances of geo-location data 114, a an content object 116, and/or geo-location rules 117.

Geo-location data 114 may include suitable data used to identify a geo-location. For example, geo-location data 114 many include country/country code, region, city, latitude, longitude, altitude, zip code, time zone, connection speed, Internet service provider (ISP), domain name, Internet protocol (IP) address, area code, mobile cellular device carrier, hardware, software, and/or model information, and/or other suitable data. In some implementations, the geo-location data 114 can be accessed, created, updated, and/or deleted by the content provider manager 107 (described below) and/or the geo-location engine 108 (described below). In some implementations, the geo-location data 114 can be associated with a particular user configuration (not illustrated), client 140, and/or content object 116 (described below). In some implementations, the client 140 can access, create, update, and/or delete geo-location data 114.

Content object 116 can be considered a representation of an intelligible business and/or non-business entity, such as a portal page, specific content associated with a portal page, an account, an order, employee, an invoice, a financial report, etc. that is associated with one or more particular content provider managers 107 (described below). The content object 116 may encompass both functions, for example in the form of methods, and data, such as one or more properties. For example, a portal page content object 116 may have properties such as, title, default resolution, default content, URL, geo-location permission, geo-location threshold, etc. Object(s) 116 may reduce system complexity by reducing a system into smaller units. The implementation details of Object(s) 116 are typically hidden from a non-development user and may be accessed through the defined functions and encapsulated data. Object(s) 116 also form a point of entry of the functions and data of an EP and enable the system to easily share, communicate, display, or otherwise operate with other systems including other EPs. An content object 116 may also be considered the target of a request for portal content, for example through a portal page, and may contain a view to be displayed when the content object 116 is accessed. In some implementations, the content object 116 can control the location of a selected view, personalized views for a specific portal user, and dynamic views. While illustrated as integrated with memory 110 of the EPS 102 in the example distributed computing system 100, in alternative implementations the content object 116 can be stored external to the EPS 102.

Geo-location rules 117 may represent conditions, parameters, variables, algorithms, instructions, constraints, references, and any other appropriate information to determine whether a particular geo-location is considered within a permitted geo-location threshold. For example, a received geo-location can be represented by a coordinate with a tolerance of +/−15 meters. The geo-location rules 117 can indicate that given the particular geo-location, a permitted geo-location threshold extends at least +300 m from the geo-location in all directions so the geo-location is considered to be within a permitted geo-location threshold. In another example, the geo-location may be on the boundary of a defined geo-location threshold and the tolerance of the geo-location could place the geo-location outside of the defined geo-location threshold. In this case the rules may determine that the geo-location is outside of the geo-location threshold or raise a caution event. In some implementations, the raising of a caution can result in a re-calculation of the geo-location to attempt to determine its location more precisely. In some implementations, the geo-location rules 117 can be stored in a database, flat file, or other suitable data structure. In some implementations, the geo-location rules 117 can be updated regularly to reflect dynamically changing geo-location permission requirements. The geo-location rules 117 may be stored remotely from the EPS 102. The geo-location rules 117 may be accessed, for example, via a Web service, a remote access system or software, a local or remote client 140, or other suitable system component.

The content provider manager 107 is any application of any type that enables the client 140 to request and view on the client 140 portal content associated with the content provider manager 107 after obtaining content from the EPS 102 and/or a content provider (not illustrated) in response to a received request from the client 140 and a determination that the client 140 is within a permitted geo-location to view the requested portal content. In some implementations, the content provider manager 107 can act as a “gate” to client-requested content until a determination that the client 140 is within a permitted geo-location threshold. In other implementations, the content provider manager may request a determination of the client 140's geo-location from the geo-location engine 108 and/or determine a client 140's geo-location in relation to the permitted geo-location threshold before serving content requested by the client 140. A content provider may be, for example, applications and data on the EPS 102 and/or external services, business applications, business application servers, databases, RSS feeds, document servers, web servers, streaming servers, caching servers, or other suitable content sources.

In some implementations, the content provider manager 107 can determine whether requested portal content is associated with a geo-location permission. In some implementations, the content provider manager 107 can determine whether a client 140 is within a permitted geo-location threshold to view requested content. For example, with a received geo-location from the client 140, the content provider manager 107 can use the geo-location rules 117 to determine whether the geo-location is within the permitted geo-location threshold. In some implementations, the content provider manager 107 can interface with the geo-location engine 108 (described below) in order to perform the determination of whether the client is within a permitted geo-location threshold and therefore permitted to view requested content. In some implementations, the content provider manager 107 also allows connections to various content providers, queries the various content providers with regard to available/provided content, and enables a user to view, add, edit, and/or delete content associated with the EPS 102.

In some implementations, the content provider manager 107 can use content provider manager data (not illustrated) or other suitable data stored in content provider manager 107, for example, data from the memory 110, to perform tasks associated with the EPS 102 or other components of the example distributed computing system 100. Content provider manager data may include any type of data associated with and/or used by the content provider manager 107, including content provider locations, addresses, storage specifications, content lists, access requirements, or other suitable data. For example, for a database content provider, the content provider manager data may include permitted geo-locations for specific types of data, a server Internet Protocol (IP) address, URL, access permission requirements (including permissions related to geo-locations), data download speed specifications, and/or other suitable data.

Once a particular content provider manager 107 is launched, a client 140 may interactively process a task, event, or other information associated with the EPS 102. The content provider manager 107 can be any application, program, module, process, or other software that may determine, execute, change, delete, generate, or otherwise manage information associated with a particular client 140, and in some cases, a business process (not illustrated) performing and executing business process-related events on the EPS 102 and/or the client 140. For example, the content provider manager 107 may be a portal application, a business application, and/or other suitable application consistent with this disclosure. Additionally, a particular content provider manager 107 may operate in response to and in connection with at least one request received from other content provider managers 107, including a content provider manager 107 associated with another EPS 102. In some implementations, the content provider manager 107 can be and/or include a web browser. In some implementations, each content provider manager 107 can represent a network-based application accessed and executed using the network 130 (e.g., through the Internet, or using at least one cloud-based service associated with the content provider manager 107). For example, a portion of a particular content provider manager 107 may be a web service associated with the content provider manager 107 that is remotely called, while another portion of the content provider manager 107 may be an interface object or agent bundled for processing at a remote client 140. Moreover, any or all of a particular content provider manager 107 may be a child or sub-module of another software module or enterprise application (not illustrated) without departing from the scope of this disclosure. Still further, portions of the particular content provider manager 107 may be executed or accessed by a user working directly at the EPS 102, as well as remotely at a corresponding client 140. In some implementations, the EPS 102 can execute the content provider manager 107.

The geo-location engine 108 can be any application, program, module, process, or other software used to provide a location-based application content security mechanism to protect portal content. For example, the geo-location engine 108 can interface with the content provider manager 107 to determine if certain access to portal content is permitted or denied based on the geo-location of a client requesting portal content. In some implementations, operation of the location-based security mechanism by the geo-location engine 108 may include a determination if certain requested portal content has established geo-location permissions, requesting a geo-location of a portal content requesting client device, and a determination if the received client geo-location is within a required geo-location threshold associated with at least one geo-location point associated with the established geo-location permission. For example, in some implementations, the geo-location data 114 in the memory 110 can be cross-referenced with the geo-location information sent from the client 140 to determine if the received client 140 geo-location satisfies a particular geo-location permission.

In some implementations, the determination can use computational power from the processor 106 and/or processor 144 (described below) associated with the client 140. Alternatively, in some implementations, the geo-location engine 108 can include a dedicated hardware and/or virtual processor to perform its functions.

In some implementations, the EPS 102 receives a request for portal content from the client 140. The request is processed by the content provider manager 107, which determines whether the requested portal content has an established geo-location permission. Based on a determination that the requested portal content has an established geo-location permission, i.e., the content is served by the content provider manager 107 to the requesting client 140 when a determination of the geo-location of the client indicates that the client is within a geo-location satisfying the geo-location permission. For example, the geo-location permission may be met when the geo-location of the client 140 is within a required geographic threshold associated with a geo-location data point associated with the geo-location permission. The geo-location data point may be established by a map coordinate, a global positioning system (GPS) coordinate, an address, a defined location, and/or other suitable data. In some implementations, the client 140 includes a location sensor 142 that can receive and determine the map coordinates, GPS coordinates, address, and/or other suitable geo-location of the client 140. For example, the location sensor 142 may be a GPS receiver, a cellular signal receiver, a wireless Internet signal receiver, or other appropriate signal receiver that can determine the geo-location of the client 140. The location sensor 142 may use various algorithms or methods, such as triangulation, to calculate and determine the geo-location of the client 140. In some implementations, the IP address of the client 140 may be used to identify the location of the client 140.

The geo-location engine 108 may receive user-defined threshold parameters that define the geo-location threshold associated with a geo-location data point. For example, a user can pre-define one or more geo-location data points that enable access of particular portal content that requires established geo-location permission. The geo-location data points can indicate a specific building, a point on a map, a geographical region, and/or specific coordinate(s). The threshold parameters can include at least one of an error tolerance, a permission radius, a time, a date, a result of a dynamic calculation, or an external event. A geo-location data point with a threshold parameter of a permission radius can define a permission zone from which the client 140 is allowed to access certain portal content that requires geo-location permission. This geo-location based security mechanism can shield sensitive portal content from being accessed, viewed, or displayed in areas other than the permitted area.

In some implementations, in addition to the geo-location based permission, a number of other authorization and/or authentication criteria can be required at the content provider manager 107 for accessing the portal content. For example, the additional authorization/authentication criteria may include a user name, a user role, a user group, and the associated authentication methods (e.g., password, biometric data, or other authentication data). In one example scenario, a user requests to access portal content from a client device. The user may first log onto a portal at the client 140 with identification and authentication information, such as user name and password. The user identification can give a role and/or certain administrative power to the user in the portal, such as access to certain sensitive or high profile portal content. Some of the sensitive or high profile portal content can require geo-location based permission and the content can only be accessed and/or displayed when the client 140 is determined to be within a particular geo-location. If the client 140 is within a permissible geo-location, the user can then access and/or display the content that requires geo-location permission; otherwise the requests for the content can be denied.

In some implementations, the definition of a permissible geo-location can be defined by an administrator on the EPS 102. For example, at the content provider manager 107, the administrator can associate portal content with geo-location data 114 stored at the memory 110. The geo-location data can include a map coordinate, a GPS coordinate, a standardized address, or other defined location. In some instances, the administrator is provided an interactive map to select and define the permissible geo-location. For example, the administrator can select a location by electronically dropping a pin on an electronic map (e.g., based on a map service). The administrator may also select a location by entering an address. In some cases, the administrator may define a permissible radius to define a permissible area associated with the location. Alternatively, the administrator may draw a shape, for example a circle, polygon, and/or other suitable shape, on the electronic map to encompass a permissible area. In some instances, the administrator may define an altitude of the location (e.g., above or below a defined altitude).

A particular geo-location engine 108 may operate in response to and in connection with at least one request received from other content provider managers 107, including a geo-location engine 108 associated with another EPS 102. In some implementations, the geo-location engine 108 can include a web browser. In some implementations, each geo-location engine 108 can represent a network-based application accessed and executed using the network 130 (e.g., through the Internet, or using at least one cloud-based service associated with the geo-location engine 108). For example, a portion of a particular geo-location engine 108 may be a web service associated with the geo-location engine 108 that is remotely called, while another portion of the geo-location engine 108 may be an interface object or agent bundled for processing at a remote client 140. Moreover, any or all of a particular geo-location engine 108 may be a child or sub-module of another software module or enterprise application (not illustrated) without departing from the scope of this disclosure. Still further, all or portions of the particular geo-location engine 108 may be executed or accessed by a user working directly at the EPS 102, as well as remotely at a corresponding client 140.

The client 140 may be any computing device operable to connect to or communicate with at least the EPS 102 using the network 130. In general, the client 140 comprises an electronic computing device operable to receive, transmit, process, and store any appropriate data associated with the example distributed computing system 100. The client includes a processor 144, a client application 146, a memory 148, and/or an interface 152.

The client application 146 is any type of application that allows the client 140 to navigate to/from, request, view, edit, delete, and or manipulate content on the client 140. In some implementations, the client application 146 can be and/or include a web browser. In some implementations, the client-application 146 can use parameters, metadata, and other information received at launch to access a particular set of data from the EPS 102. Once a particular client application 146 is launched, a user may interactively process a task, event, or other information associated with the EPS 102. Further, although illustrated as a single client application 146, the client application 146 may be implemented as multiple client applications in the client 140. In some implementations, the client application 146 may act as a GUI interface for the memory 110 and/or other components of EPS 102 and/or other components of the example distributed computing environment 100.

The interface 152 is used by the client 140 for communicating with other computing systems in a distributed computing system environment, including within the example distributed computing system 100, using network 130. For example, the client 140 uses the interface to communicate with the EPS 102 as well as other systems (not illustrated) that are communicably coupled to the network 130. The interface 152 may be consistent with the above-described interface 104 of the EPS 102 or other interfaces within the example distributed computing system 100. The processor 144 may be consistent with the above-described processor 106 of the EPS 102 or other processors within the example distributed computing system 100. Specifically, the processor 144 executes instructions and manipulates data to perform the operations of the client 140, including the functionality required to send requests to the EPS 102 and to receive and process responses from the EPS 102. The memory 148 may be consistent with the above-described memory 110 of the EPS 102 or other memories within the example distributed computing system 100 but storing objects and/or data associated with the purposes of the client 140, including site maps, cached data, container documents, GUI elements, and crowd-source information similar to that stored in memory 110 of EPS 102. In some implementations, the memory 148 may be used by EPS 102 to store objects and/or data.

Further, the illustrated client 140 includes a GUI 142. The GUI 142 interfaces with at least a portion of the example distributed computing system 100 for any suitable purpose, including generating a visual representation of a web browser. The GUI 142 may be used to view and navigate various web pages located both internally and externally to the EPS 102. In particular, the GUI 142 may be used to perform functions for providing assisted portal navigation and crowd-based feedback consistent with this disclosure.

There may be any number of clients 140 associated with, or external to, the example distributed computing system 100. For example, while the illustrated example distributed computing system 100 includes one client 140 communicably coupled to the EPS 102 using network 130, alternative implementations of the example distributed computing system 100 may include any number of clients 140 suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer 140a, laptop/notebook computer 140b, wireless data port (not shown), tablet computing device 140c, smart phone 140d, personal data assistant (PDA), one or more processors within these devices, or any other suitable processing device. For example, the client 140 may comprise a computer that includes an input device, such as a keypad, touch screen, or other device that can accept user information, and an output device that conveys information associated with the operation of the EPS 102 or the client 140 itself, including digital data, visual and/or audio information, or a GUI 142, as shown with respect to the client 140.

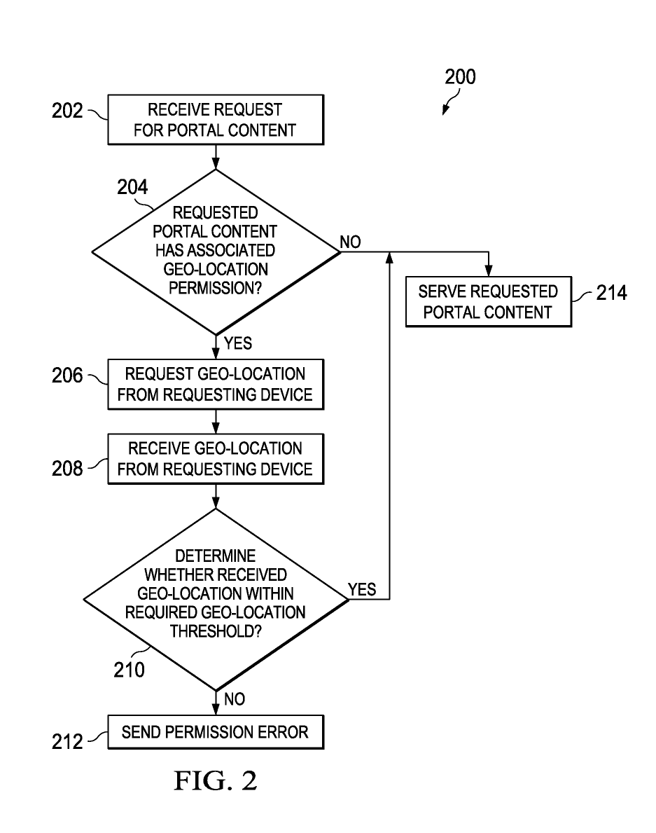

FIG. 2 is a flow chart illustrating a method 200 for providing a location-based application security mechanism to a web portal. The method 200 can be applied to the distributed computing system 100 as illustrated in FIG. 1 or other similar portal system supporting various business applications.

At 202, an EPS receives request for portal content, for example by requesting a particular content object. The EPS includes authorization and authentication mechanisms based on various user attributes, such as user name, role, group, location, etc. The request for portal content may be sent as the user logs onto the portal in a certain role. For example, a user with a role of “Sales Manager” can access a “Regional Sales Summary” application. Other users not assigned to the same “Sales Manager” role may be denied access to the “Regional Sales Summary” application. In other words, the requested portal content may be managed by an inherent administrative environment that can assign and provide permissions to business applications for a specific user, user groups or roles.

At 204, the EPS determines whether the requested portal content has an associated geo-location permission. In some implementations, the geo-location permission can be a property of the particular content object holding the requested portal content. In some implementations, the content provider manager determines whether the requested portal content is associated with a geo-location permission. In other implementations, the geo-location engine can wholly or partially determine whether the requested portal content is associated with the geo-location permission. In some implementations, the content provider manager and the geo-location engine can cooperatively determine whether the requested portal content is associated with the geo-location permissions.

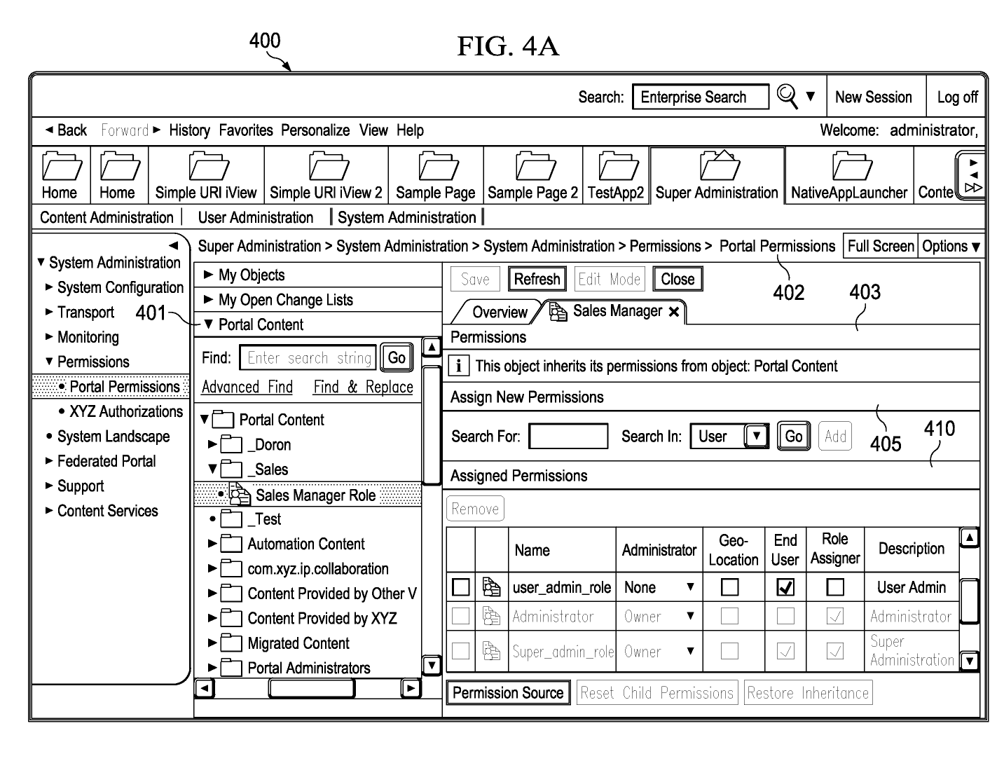

In some implementations, the geo-location permission can be set as part of a permission setting in an administrative environment associated with the EPS. Examples of user interfaces within an example administrative environment used to set geo-location permissions are illustrated in FIGS. 4A and 4B (described in greater detail below).

Based on the determination that the requested portal content is not associated with a geo-location permission, at 216, the EPS serves the requested portal content. Otherwise, based upon the determination that the requested portal content is associated with the geo-location permission, at 206, the EPS requests geo-location from the requesting device. The requesting device may determine its geo-location using various methods/technologies, such as HTML5 geo-location tags, GPS, cellular carrier signal triangulation, wireless Internet signal triangulation, and other suitable methods.

At 208, the EPS receives a geo-location from the requesting device. The geo-location can be a data point and/or range established by at least one of a map coordinate, a GPS coordinate, an address, or a location. The geo-location information may be processed by the content provider manager, the geo-location engine, and/or a portal runtime container (not illustrated) which can match the received geo-location with geo-location rules associated with the content provider manager.

At 210, the EPS determines whether the received geo-location is within a required geo-location threshold. The geo-location threshold can be defined by various threshold parameters. For example, one threshold parameter can include a permissible radius defined on a permissible location (e.g., a building) that allows the determination of an allowable area within a defined circumference centered on the example building in which a request for the location-restricted content is permissible. In some implementations, the threshold parameters can further include a time, a date, a result of dynamic calculation, or an external event. For example, certain areas may be permissible for a particular event, allowing for a larger or a smaller permissible area in a particular time period. In some implementations, the threshold parameters can be one or more properties associated with the content object, values associated with the geo-location data, the geo-location engine, and/or the content provider manager.

Upon a determination that the received geo-location is within the geo-location threshold, at 216, the EPS serves the requested portal content to the client 140. Otherwise, at 214, the EPS sends an error message explaining the request for portal content has been denied as a result of not satisfying the geo-location requirement.

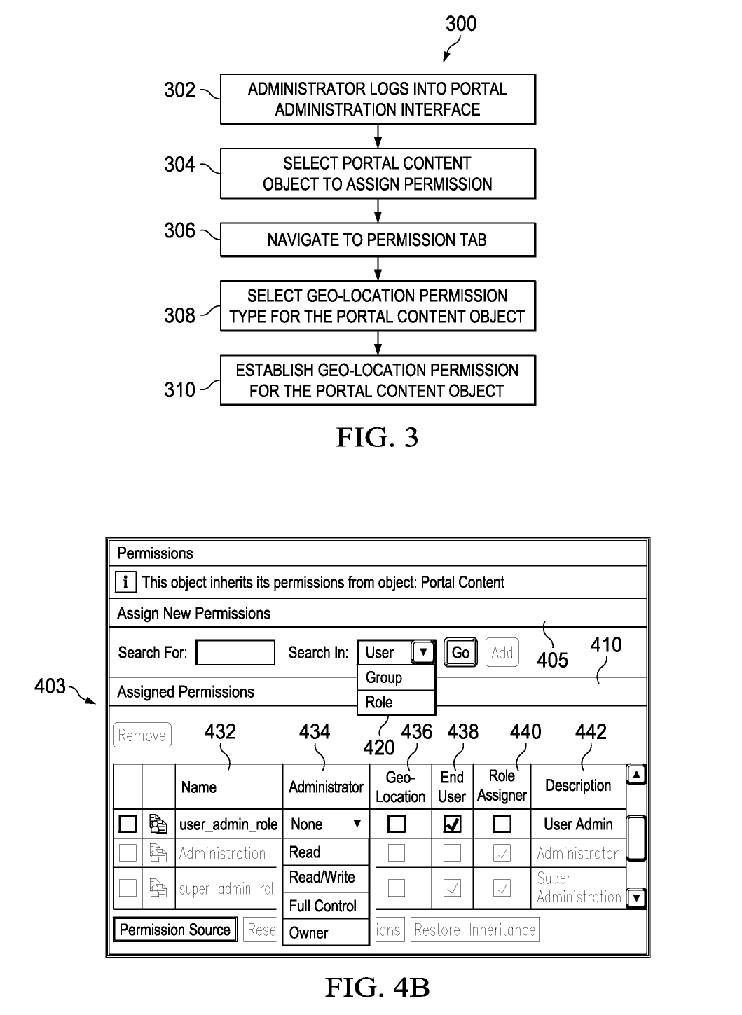

FIG. 3 is a flow chart illustrating a method 300 for a web portal administrator to set up a location-based application security mechanism. Method 300 is used to set up permission threshold parameters and/or associated geo-location rules with a content provider manager and/or content object

At 302, the web portal administrator logs into a web portal administration interface. An example portal administration interface is illustrated and described in relation to FIGS. 4A and 4B. The web portal administrator may access the web portal administration interface using the EPS or a client device connected to the EPS. The web portal administration interface can include a number of fields for the web portal administrator to define and/or assign geo-location permission criteria, thresholds, values, parameters, etc.

At 304, the web portal administrator selects one or more portal content objects to associate one or more permissions with. For example, the web portal administrator may select portal content objects related to a particular class, role, group, or other classified levels that are intended to be associated with geo-location permission.

At 306, the web portal administrator navigates to a permission tab or an appropriate permission selector.

At 308, the web portal administrator selects a geo-location permission type for the portal content object. The selected geo-location permission restricts access, display, modification, or other suitable actions associated with the portal content object based upon a requesting client's geo-location.

At 310, the web portal administrator specifies geo-permission parameters associated with the selected geo-location permission type for the portal content object. In some implementations, the geo-permission parameters are stored with the portal content object. In other implementations, the geo-permission parameters can be stored in memory 110 and/or other suitable memory associated with the example distributed computing system. For example, the web portal administrator may define a radial area to be associated with a particular address (e.g., a single geo-location data point) and a radius value in order to define a radial geo-threshold, a geo-threshold defined by an area that encompasses multiple coordinate geo-location data point, etc. In some implementations, the geo-location threshold for one or more geo-location data points can be defined in any practical manner to specify a geographical region, zone, or “threshold” surrounding/encompassing the one or more geo-location data points. For example, a GUI could be used, a flat file, a database, or other suitable method.

Geo-permission parameters can include a geo-location data point that is a map coordinate, a GPS coordinate, an address, or other defined location. For example, a pop-up window can be displayed as the web portal administrator selects to set the geo-permission parameters. The pop-up window can include an interactive map for the web-portal administrator to zoom, pan, and select a point on the map. The pop-up window may also include fields for the web-portal administrator to define geo-permission parameters such as effective radius, coordinates, addresses, and other values. The geo-permission parameters can define a permissible region within which a requested portal content object may be accessed. If a client device is located outside the permissible region, access to the portal object is then denied. Other geo-permission parameters may be defined, such as a time, a date, a result of dynamic calculation, or an external event. A dynamic calculation can be based on one or more geo-permission parameters that change, such as time, date, season, etc.

FIGS. 4A and 4B are example portal administration interfaces providing functionality to establish a location-based application security mechanism. In FIG. 4A, a portal administration interface 400 is shown. The administration interface 400 includes various elements for administrators to select and define administrative attributes. For example, a portal content tab 401 can be selected to display a list of objects for setting portal permission parameters 402. The portal permission parameters 402 can be expanded under a control hierarchy under permissions under system administration. Portal permission parameters 402 may be sent for other objects besides portal content, such as “My Objects”. An administrator can select a particular entry in the list of portal content 401 to define permission parameters. For example, the content of sales can be selected to open a permission setting window 403 for defining permission parameters. The permission window 403 includes an interface 405 for assigning new permissions and an interface 410 for setting current assigned permissions.

In FIG. 4B, details of the permission setting interface 403 are shown. The interface 405 can include a search entry and a search setting 420. The search setting can be selected at least among a user, group, or role. The search setting is for finding an object to be assigned with new permissions. For example, if a particular content object is searched for by name, new permissions may be associated with the particular content object found by the searched for name. The interface 410 includes one or more property columns of name 432, administrator 434, geo-location permission 436, end user 438, role assigner 440, and description 442 used to define geo-permission parameters. For example, an attribute of “user admin role” under attribute name 432 can be assigned with one of the administrator authorization values 434 (e.g. read, read/write, full control, and owner). Each of the authorization values 434 may then be associated with a property defined using the geo-location 436 column. In some implementations, setting a value for the geo-location column 436 can activate any suitable GUI or other user interface to permit the web portal administrator to set various geo-permission parameters such as a map location, coordinates, radius, address, threshold, or to otherwise define any other suitable geo-permission parameter.

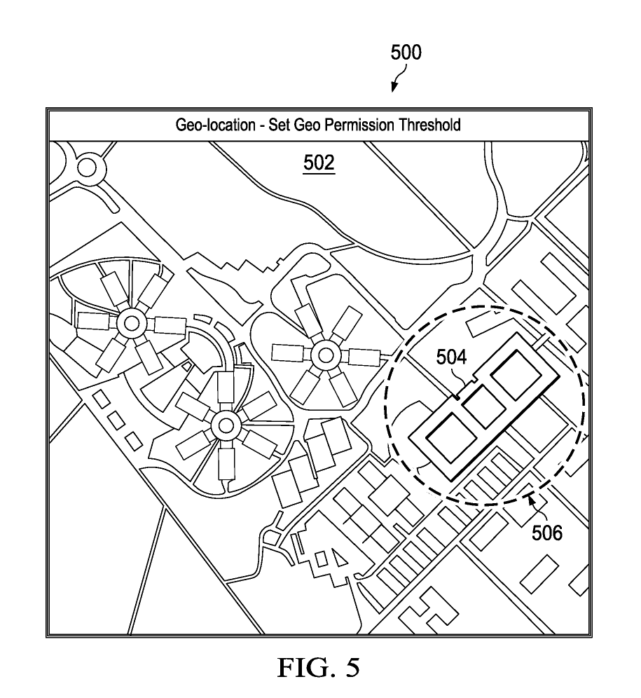

FIG. 5 is a block diagram of an example map interface 500 for setting a geo-location geo-permission threshold. Map 502 is presented in the example map interface 500. As illustrated, there are aerial views of various buildings, for example building 504. Using the example map interface 500, portal administration can select a geo-location geo-permission threshold 506 by using a geometric shape to indicate the extent of the geo-permission threshold 506. In this example, the geo-permission threshold 506 is illustrated as a dashed circle, but could be represented by any shape, such as a square, rectangle, triangle, etc. Alternative suitable interfaces allowing entry of coordinates, numerical values, and other suitable data to specify the geo-permission threshold 506 are also envisioned.

While, FIGS. 4A-4B and FIG. 5 illustrate and describe various example web portal administrative interfaces, FIGS. 4A-4B and FIG. 5 are meant only as representative examples of many possible implementations and are not meant to limit in any way providing a location-based application content security mechanism to a web portal. Those of skill in the art will appreciate the multitude of possible implementations that may be used to accomplish the described functionality.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program include, by way of example, can be based on general or special purpose microprocessors or both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving a request for portal content from a client device;
determining that the requested portal content has an established geo-location permission, wherein the geo-location permission is a property of a content object holding the portal content;
requesting a client geo-location from the requesting client device;
receiving the client geo-location from the requesting client device;
determining, by operation of a computer, that the received client geo-location is within a required geo-location threshold value of at least one geo-location data point associated with the established geo-location permission property; and
serving the portal content to the requesting client device.

2. The computer-implemented method of claim 1, wherein the at least one geo-location data point is established by at least one of a map coordinate, a global positioning system (GPS) coordinate, an address, or a location.

3. The computer-implemented method of claim 1, wherein the client geo-location is determined by at least one of a global positioning system (GPS) receiver in the client device, a triangulation-based method using cellular signals, a triangulation-based method using wireless Internet signals, or an Internet protocol (IP) address.

4. The computer-implemented method of claim 1, wherein the geo-location threshold can vary based upon threshold parameters.

5. The computer-implemented method of claim 4, wherein the threshold parameters include at least one of a time, a date, a result of a dynamic calculation, or an external event.

6. The computer-implemented method of claim 1, further comprising checking a plurality of authorization criteria associated with the request for portal content.

7. The computer-implemented method of claim 6, wherein the plurality of authorization criteria comprises at least one of a user name, a user role, or a user group.

8. The computer-implemented method of claim 1, further comprising, in response to determining that the received specific geo-location is outside the required geo-location threshold, sending a notification indicating a denial of access to the requested portal content based upon the client geo-location.

9. A non-transitory, computer-readable medium storing computer-readable instructions executable by a computer to:
receive a request for portal content from a client device;
determine that the requested portal content has an established geo-location permission, wherein the geo-location permission is a property of a content object holding the portal content;
request a client geo-location from the requesting client device;
receive the client geo-location from the requesting client device;
determine, by operation of a computer, that the received client geo-location is within a required geo-location threshold value of at least one geo-location data point associated with the established geo-location permission property; and
serve the portal content to the requesting client device.

10. The computer-readable medium of claim 9, wherein the at least one geo-location data point is established by at least one of a map coordinate, a global positioning system (GPS) coordinate, an address, or a location.

11. The computer-readable medium of claim 9, wherein the client geo-location is determined by at least one of a global positioning system (GPS) receiver in the client device, a triangulation-based method using cellular signals, a triangulation-based method using wireless Internet signals, or an Internet protocol (IP) address.

12. The computer-readable medium of claim 9, wherein the geo-location threshold can vary based upon threshold parameters.

13. The computer-readable medium of claim 12, wherein the threshold parameters include at least one of a time, a date, a result of a dynamic calculation, or an external event.

14. The computer-readable medium of claim 9, further comprising instructions to check a plurality of authorization criteria associated with the request for portal content.

15. The computer-readable medium of claim 14, wherein the plurality of authorization criteria comprises at least one of a user name, a user role, or a user group.

16. The computer-readable medium of claim 9, further comprising, in response to determining that the received specific geo-location is outside the required geo-location threshold, instructions to send a notification indicating a denial of access to the requested portal content based upon the client geo-location.

17. A computer system, comprising:
at least one computer configured to:
receive a request for portal content from a client device;
determine that the requested portal content has an established geo-location permission, wherein the geo-location permission is a property of a content object holding the portal content;
request a client geo-location from the requesting client device;
receive the client geo-location from the requesting client device;
determine, by operation of a computer, that the received client geo-location is within a required geo-location threshold value of at least one geo-location data point associated with the established geo-location permission property; and
serve the portal content to the requesting client device.

18. The computer system of claim 17, wherein the at least one geo-location data point is established by at least one of a map coordinate, a global positioning system (GPS) coordinate, an address, or a location.

19. The computer system of claim 17, wherein the client geo-location is determined by at least one of a global positioning system (GPS) receiver in the client device, a triangulation-based method using cellular signals, a triangulation-based method using wireless Internet signals, or an Internet protocol (IP) address.

20. The computer system of claim 17, wherein the geo-location threshold can vary based upon threshold parameters.

21. The computer system of claim 20, wherein the threshold parameters include at least one of a time, a date, a result of a dynamic calculation, or an external event.

22. The computer system of claim 17, further configured to check a plurality of authorization criteria associated with the request for portal content.

23. The computer system of claim 22, wherein the plurality of authorization criteria comprises at least one of a user name, a user role, or a user group.

24. The computer system of claim 17, further configured, in response to determining that the received specific geo-location is outside the required geo-location threshold, to send a notification indicating a denial of access to the requested portal content based upon the client geo-location.
